(19) United States
(12) Patent Application Publication
(10) Pub. No.: US 2005/0175362 A1
(43) Pub. Date: Aug. 11, 2005

(54) Optical spectrometer and method

(76) Inventor: Gordon Wilson, San Francisco, CA (US)

Correspondence Address: Jeffery J. Brosemer, Ph.D., ESQ., LLC, 138 S. Telegraph Hill Road, Holmdel, NJ, 07733, US

(21) Appl. No.: 10/784,081

(22) Filed: Feb. 21, 2004

Related U.S. Application Data
(60) Provisional application No. 60/538,523, filed on Jan. 22, 2004.

(51) Int. Cl. G11B 11/00; H04B 10/06

(52) U.S. Cl. 398/212

(57) ABSTRACT

An optical apparatus and associated method(s) that utilize zeroth-order feedback to provide precise positional information about optical components comprising the optical apparatus.

### CROSS REFERENCE TO RELATED APPLICATIONS

This application claims the benefit of U.S. Provisional Application No. 60/538,523 filed Jan. 22, 2004.

### FIELD OF THE INVENTION

This invention relates generally to the field of optical apparatus and in particular to an optical spectrometer and related method(s), suitable for use in single channel, or multiple-channel wavelength division multiplexed (WDM) communications systems or other optical systems.

### BACKGROUND OF THE INVENTION

Optical communication systems oftentimes use wavelength-division multiplexing to increase transmission capacity. More specifically, a plurality of optical signals, each having a different wavelength, are multiplexed together into a WDM signal. The WDM signal is transmitted over a transmission line, and then subsequently demultiplexed so that individual optical signals may be individually received.

Successful implementation of high-speed WDM system depends upon the development of optical devices at reasonable cost. In particular, WDM systems, and other industries as well, require devices that provide the sorting and/or separation of wavelengths, for routing, measurement, or other purposes. One such device—an optical spectrometer and related method(s)—is the subject of the present invention.

### SUMMARY OF THE INVENTION

I have invented an optical spectrometer and associated method(s) that offers a number of advantages over existing optical spectrometers and method(s).

Viewed from a first aspect, my invention is directed to an optical spectrometer method utilizing zeroth-order feedback to provide precise positional information.

Viewed from another aspect my invention is directed to an optical spectrometer apparatus that accepts a plurality of input signals and provides a plurality of output signals, and may utilize my inventive zeroth-order feedback.

Additional objects and advantages of my invention will be set forth in part in the description which follows, and, in part, will be apparent from the description or may be learned by practice of the invention.

### BRIEF DESCRIPTION OF THE DRAWING

FIG. 1 is a schematic representation of an optical arrangement according to the present invention;

FIG. 2 is a schematic representation of an alternative embodiment of an optical arrangement according to the present invention;

FIG. 3 is a schematic representation of an optical arrangement including position detection according to the present invention;

FIG. 4(a-d) shows two alternative patterns (a-b) and the resulting output (c-d) of intensity vs. time respectively;

FIG. 5 is a schematic representation of an alternative arrangement of an optical arrangement including position detection and a single lens according to the present invention;

FIG. 6 is a schematic representation of an optical arrangement including a retroreflector;

FIG. 7 is a block diagram of a control system useful with and according to the present invention; and

FIG. 8 is a schematic representation of alternative mirror-grating configurations useful with, and according to the present invention.

### DETAILED DESCRIPTION

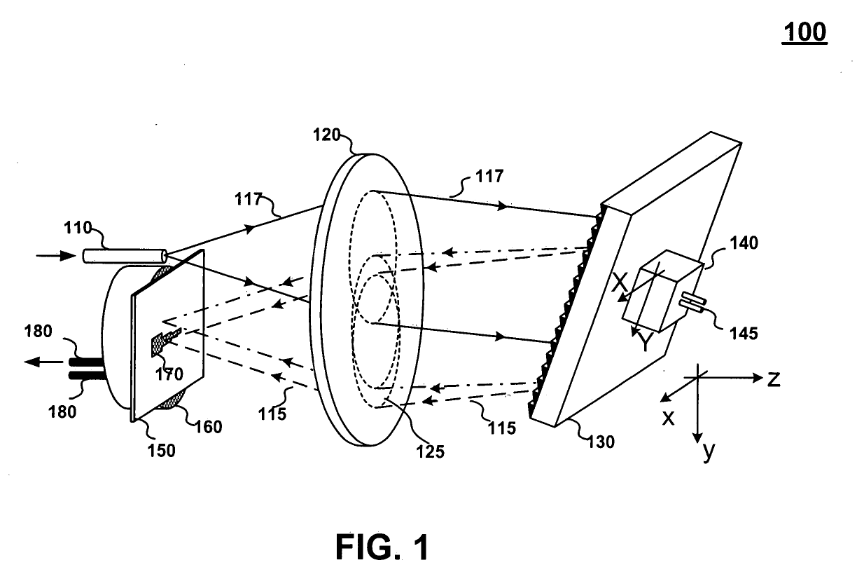

With reference now to FIG. 1, there is shown in schematic form an optical arrangement 100, which exhibits our inventive teachings. More specifically, optical arrangement 100 depicts multiwavelength input signals carried on input fiber 110 being collimated by lens 120 and illuminating planar reflective diffraction grating 130 mounted on tip/tilt stage 140 capable of rotating the grating 130 about its X-axis or Y-axis. As can be appreciated, each wavelength of the multiwavelength input signals is diffracted into an angle corresponding to the wavelength.

While the input signals are shown in FIG. 1 being carried on input fiber 110, it is understood that the input could be another type of optical waveguide, besides an optical fiber, or it could be a free-space aperture. Preferentially, the intensity profile of light in the input aperture is single-lobed, and the input numerical aperture is matched to the numerical aperture of the optics used in the optical apparatus.

Diffracted signals 115 are focused by a second pass through lens 120 and are imaged onto a permanent spectral-plane spatial filter that passes a portion of the imaged spectrum and blocks the rest. As can be readily appreciated, a broad-spectrum multi-channel signal would be imaged into a continuous column of spots on the face of the permanent spectral-plane structure.

Those portions of diffracted wavelength signal 115 which are imaged onto the opaque region and are absorbed or reflected, while the portions of wavelength signal 115 that are imaged onto the transparent aperture 170 are transmitted to illuminate an optical power detector 160 located immediately behind the aperture.

In operation, the tip/tilt stage 140 is controlled through electrical connections 145. Rotating tip/tilt stage 140 around its X-axis will steer the dispersed spectral pattern illuminating the permanent spectral-plane structure to shift vertically, and modify the center wavelength of the signal entering detector 160. In this exemplary embodiment shown in FIG. 1, the width of the aperture in the y-direction varies along the x-direction. Rotating stage 140 around its Y-axis will cause the dispersed spectral pattern illuminating the spectral-plane filter to shift laterally (as drawn, into and out of the page), and modify the wavelength bandwidth of the signal entering detector 160. As can be appreciated, with this optical arrangement, the signal can be completely blocked from the photodetector by rotating the stage about the Y-axis so that the dispersed spectrum completely misses the aperture so that the photodetector dark current can be measured and subtracted from the signal current.

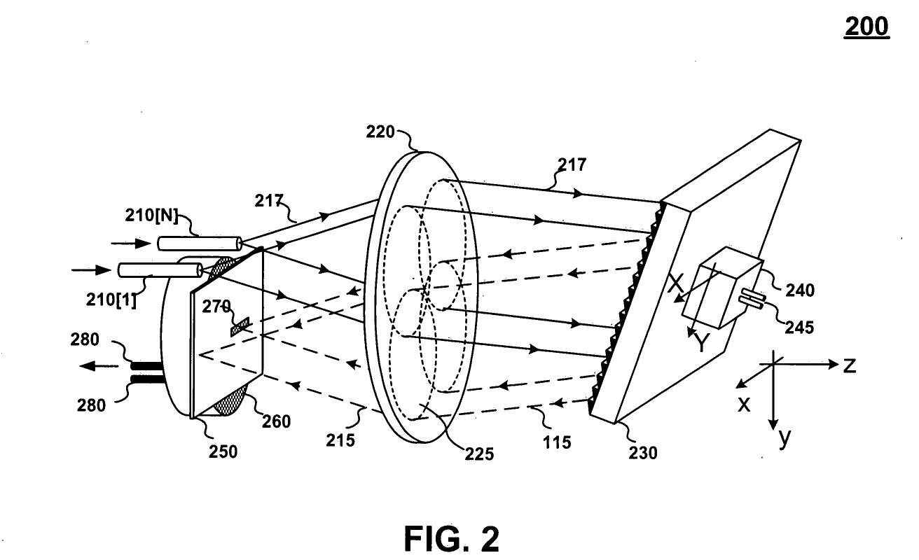

With reference now to FIG. 2, there is shown an arrangement substantially similar to that shown in FIG. 1, in which a plurality of multiwavelength signals enter the system at input points arrayed along the x axis 210[1] . . . 210[N]. Each of these inputs is imaged on the spectral plane filter structure 250 as a separate wavelength-dispersed column along the y direction. With this arrangement, the length of the aperture 270 in the x direction may be chosen such that only one column illuminates the aperture at a time. By rotating the stage about the x axis, the spectrum of one input signal is measured. By rotating the stage about the y-axis, a different signal illuminates the aperture so that its spectrum can be measured.

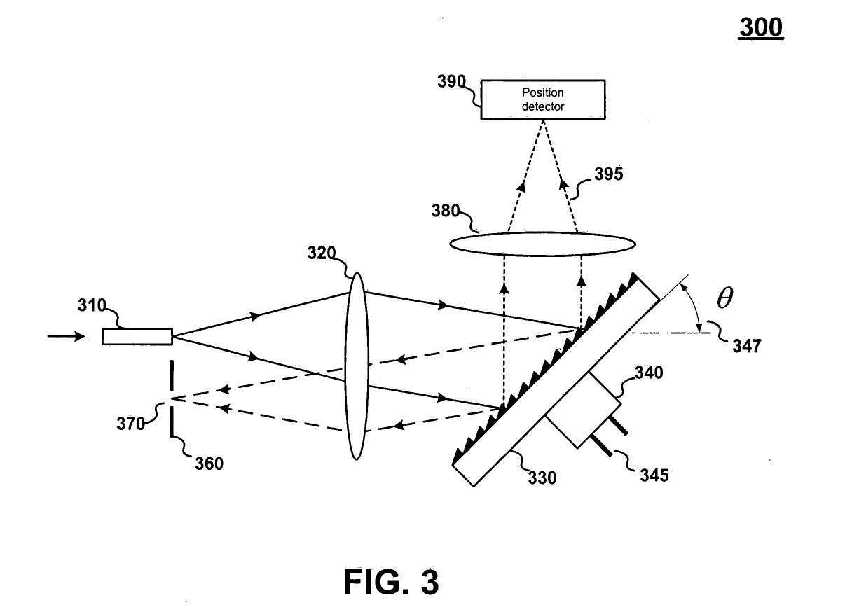

An alternative optical arrangement exhibiting additional aspects of my inventive concepts is shown schematically in FIG. 3. Shown therein is input 310, lens 320, grating 330 positioned on tip/tilt stage 340, spectral plane device 360 having aperture 370, and position detecting system including lens 380 and position detector 390.

With continued reference to FIG. 3, a multiwavelength input signal carried on input fiber 310 is collimated by lens 320 and illuminates planar reflective diffraction grating 330 mounted on tip/tilt stage 340 which, through its operation, rotates the grating about its X-axis or Y-axis, as desired. As described earlier, each wavelength signal beam is diffracted into an angle corresponding to its wavelength. Diffracted signals are focused by a second pass through lens 320 and are imaged onto a permanent spectral-plane device 360 having an exit slit aperture 370.

Provided that the system shown in the optical arrangement of FIG. 3 is mechanically stable, the wavelength of light centered on the exit slit aperture 370 is uniquely determined by the angle θ(347) of the grating 330. A drive signal V_{d} (not shown), which may be applied to tip/tilt stage electrical connectors 345, rotates the grating through angle θ according to a function θ(V_{d}). Upon calibration of the system, a correspondence can be determined between V_{d} and center wavelength λ(V_{d}) passing through the exit slit, so that the spectrum can be determined from a synchronous measurement of drive signal and photocurrent which may be measured at the exit slit 370. Unfortunately, however, θ(V_{d}) may not be completely stable—it may depend on environmental factors or may drift over time due to aging processes. Moreover, the function may be frequency dependent. Thus, a separate means of measuring θ is helpful.

As can be appreciated by those skilled in the art, the diffraction grating 330 disperses light into multiple orders. Additionally, the grating is designed to have high efficiency in one non-zeroth order, and this order is used for the spectral measurement. That fraction of the light diffracted into the zeroth-order may be used to measure the position of the stage.

In FIG. 3, the zeroth order reflects off the grating and is collected by a lens 380. As will be shown subsequently, the lens may advantageously be the same as that lens collecting the signal 320 or it may be a different lens. In this specific embodiment shown in FIG. 3, the zeroth-order-collecting lens 380 is physically distinct from the signal-collecting lens 320.

The collecting lens 320 images the zeroth order beam 395 onto a position detector 390. It will be obvious to those skilled in the art that a curved mirror (not shown) could be used in place of the lens or the grating could have optical power to image the zeroth-order beam 395 onto the position detector 390. Furthermore, and depending on the type of position detector used, the lens 380 may be omitted.

For the zeroth-order beam, the angle of reflection from the grating is independent of wavelength. Consequently, all wavelengths comprising the zeroth-order beam 395 are imaged to a common spot on the position detector 390. Thus, the position of the spot on the position detector 390 is uniquely determined by the position of the grating 330. The position detector 390 may comprise a quad-cell or bi-cell detector or a “position-sensitive detector” (PSD). Alternatively, it may include a single photodetector that may be covered by a series of apertures.

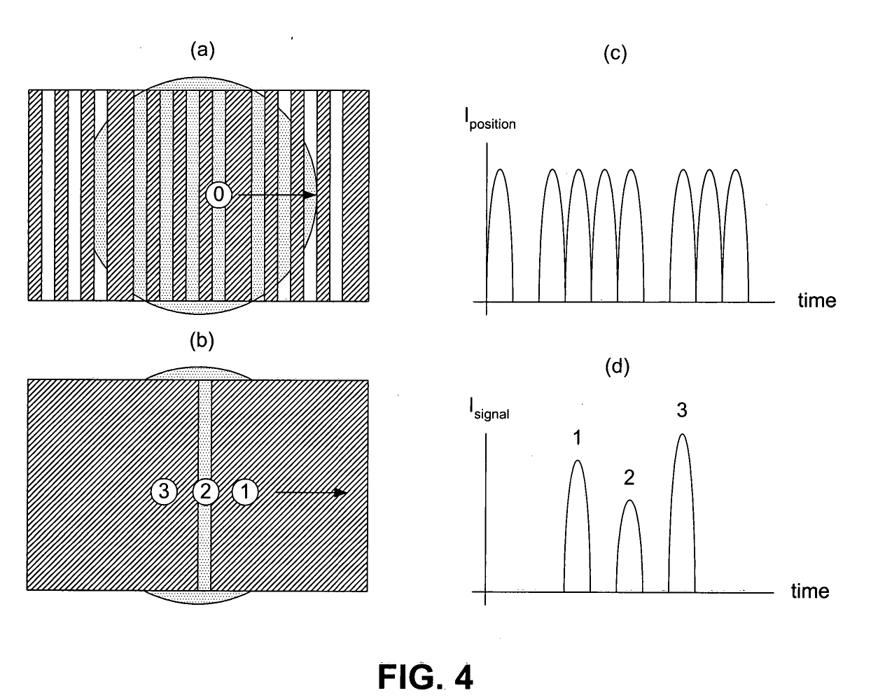

Elements of such a position detector are shown in FIG. 4. With reference to that figure, a single photodetector, for example, is positioned behind an opaque screen 4a having a series of transparent slits arranged in a periodic pattern. As a grating, such as that shown in FIG. 3 by reference numeral 330, is tilted around the x-axis, the zeroth-order spot travels horizontally to the right across the slits on the opaque screen 4a, thereby producing a series of peaks that register in the photocurrent Iₚₒₛᵢₜᵢₒₙ in a manner such as that shown in FIG. 4c.

Concurrently, and as a result of the grating being tilted, the dispersed spectrum passes across the single exit slit such as that shown prior in FIG. 3 as reference numeral 370 and now in FIG. 4b. In this example, and as noted before, the signal comprises 3 wavelength signals. The relative power of each signal is indicated by the relative powers of the peaks 1, 2, and 3 in the plot of I_{signal} v. time that is shown in FIG. 4d.

Through calibration, the correspondence between the temporal registration of the position signal and the peak transmittance of each signal wavelength onto the signal detector can be determined. This correspondence is only unique over a wavelength range Δλ that is scanned during the time it takes the zeroth-order spot in 4a to traverse one period of the position detector screen. If the uncertainty in Δ(V_{d}) is less than Δλ, then advantageously, the spectrum may be uniquely determined according to our inventive teachings by synchronous measurement of Iₚₒₛᵢₜᵢₒₙ, I_{signal}, and V_{d}.

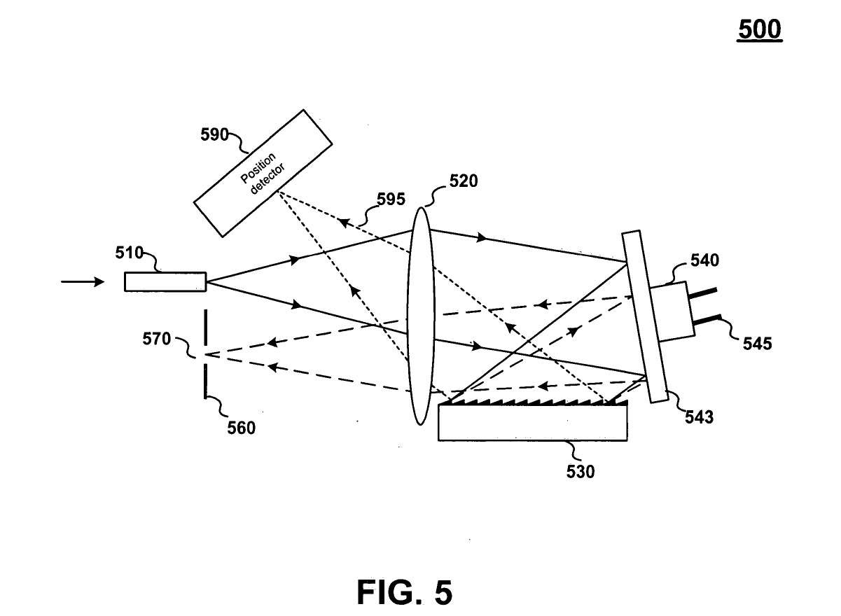

With these inventive teachings in place, alternative embodiments may now be shown. One such alternative embodiment is shown in FIG. 5, which shows an optical arrangement where a grating is fixed, and a tip-tilt mirror in positioned close proximity to it. Additionally, the two lenses utilized in the example shown earlier with FIG. 3, is now reduced to a single lens.

With specific reference now to that FIG. 5, a multiwavelength signal emerges from optical input 510, which may include an optical fiber or other suitable structures, and is collimated by lens 520 which further directs the signal to mirror 543 that is positioned on tip/tilt stage 540, which is controllably tiltable by applying appropriate signals to electrical contacts 545. Signals reflected from the mirror 543 are directed to a fixed grating 530.

As noted in my discussion of the two-lens configuration of FIG. 3, the diffraction grating 530 disperses light into multiple orders and the grating is designed to have high efficiency in one non-zeroth order, and this high-efficiency non-zero order is used for the spectral measurement. That fraction of the light diffracted into the zeroth-order may advantageously be used to measure the position of the stage.

In this example shown in FIG. 5, the zeroth-order diffracted beam 595 passes through and is focused by the same lens 520 as the multi-wavelength signal emerging from optical input 510. More specifically, the zeroth-order diffracted beam 595 is focused by the lens 520 onto a position detector 590. Simultaneously, the non-zeroth order is diffracted onto the mirror 543, where it is further reflected through lens 520 and focused onto slit 570 within spectral plane structure 560. Such a compact structure, can advantageously offer numerous design alternatives.

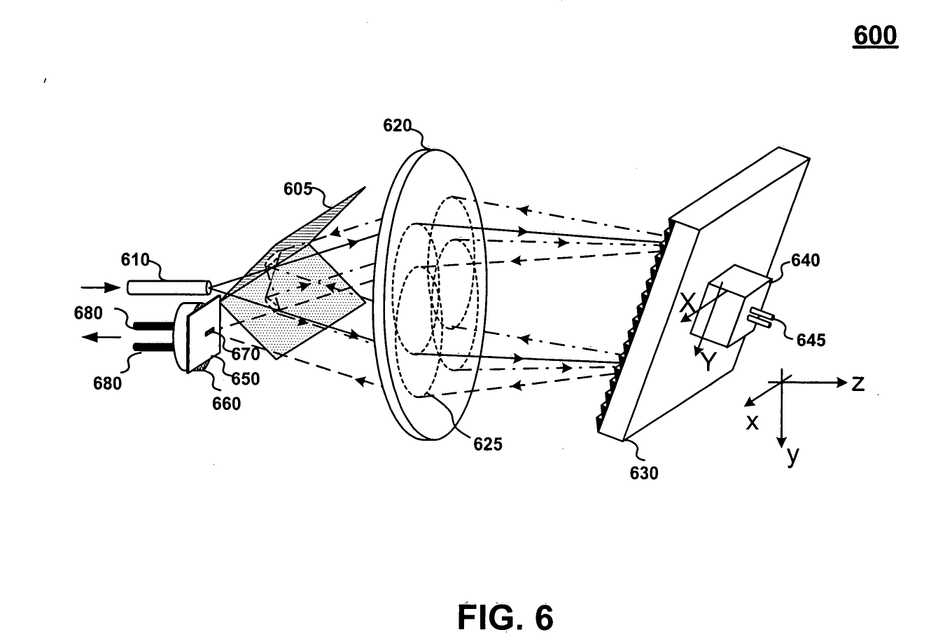

FIG. 6 shows an exemplary double-pass monochrometer constructed according to my inventive teachings. Similar to that shown in FIG. 1, and with reference to FIG. 6, 600, multiwavelength input signals carried on input fiber 610, and are collimated by lens 620 such that they illuminate planar reflective diffraction grating 630 mounted on tip/tilt stage 640 capable of rotating the grating 630 about its X-axis or Y-axis.

The diffracted signals are focused by a second pass through lens 620 at the mid point of folded retroreflector 605. The retroreflector 605 reflects the signals back through lens 620, which collimates the beam and directs it onto diffraction grating 630 for the second time. The signals are further diffracted by grating 630 and imaged by lens 620 onto a permanent spectral-plane spatial filter 650, having aperture 670. Those portions of the diffracted wavelength signal that are imaged onto the aperture 670 are transmitted to illuminate an optical power detector 660 or other device located immediately behind the aperture.

As can be seen from this arrangement, after one pass through the system, the signal is retro-reflected, through the action of retroreflector 605 about the axis perpendicular to the direction of dispersion so that the spectrum is inverted. The second pass through the system further disperses the signal so that the resolution of the system is effectively doubled. Furthermore, a spatial filter (not shown) may be inserted at the retroreflector 605 to filter out all but a band of wavelengths, thereby reducing the background light produced by omnidirectional scattering off the grating 630 in the second pass. The retroreflector 605 itself will perform spatial filtering if its clear aperture 606 is smaller than the length of the dispersed spectrum in the spectral plane.

With these inventive structures and methods in place, one can quickly appreciate the benefits that various modifications or particular implementations of my teachings will produce. In particular, and with reference now to FIG. 2, one will recall the optical apparatus 200 in which a plurality of multiwavelength signals enter the system at input points arrayed along the x axis 210[1] . . . 210[N]. Each of these inputs is imaged on the spectral plane filter structure 250 as a separate wavelength-dispersed column along the y axis. With this arrangement, the length of the aperture 270 in the x direction may be chosen such that only one column illuminates the aperture at a time. By rotating the stage about the x axis, the spectrum of one input signal is measured. By rotating the stage about the y-axis, a different signal illuminates the aperture so that its spectrum can be measured.

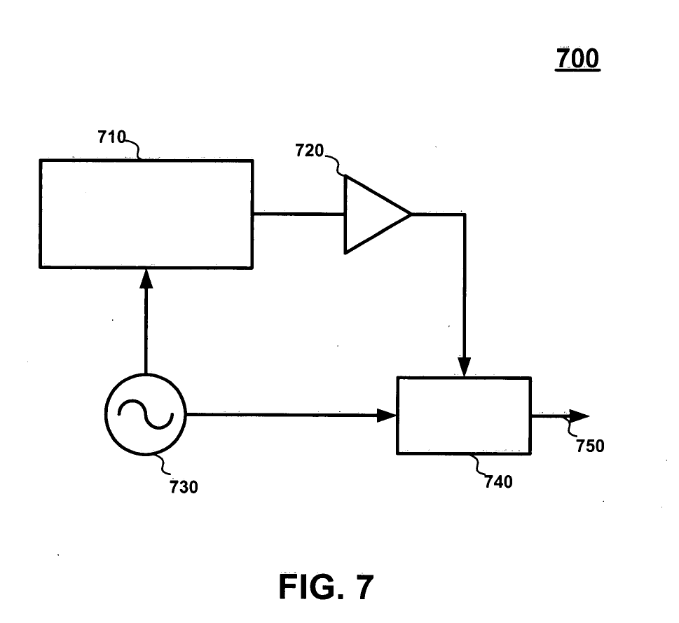

With that reference to that FIG. 2 in mind and with reference now to FIG. 7, the tip/tilt stage 240 may be periodically modulated in angle about the y-axis such that the optical signal spectrum received from one of the inputs 210[1] . . . 210[N], and imaged on the spectral plane filter 250 periodically moves on and off the aperture 270, thereby “chopping” the imaged signal. Chopping, in combination with synchronous detection using a lock-in amplifier is but one technique for improving the signal-to-noise ratio in measurements systems. In particular, the dark current of the photodetector 260 and the 1/f noise of the amplifier can be reduced this way.

A simplified block diagram of such a detection scheme is shown in FIG. 7. Specifically, optical spectrometer 710, utilizes functional input 730 to drive y-axis of the tip/tilt stage (not shown), produces I_{signal} which is supplied as input to transimpedance amplifier 720, the output of which subsequently drives lock-in amplifier 740 in conjunction with functional input 730 to produce output signal 750 having the more desirable noise characteristics.

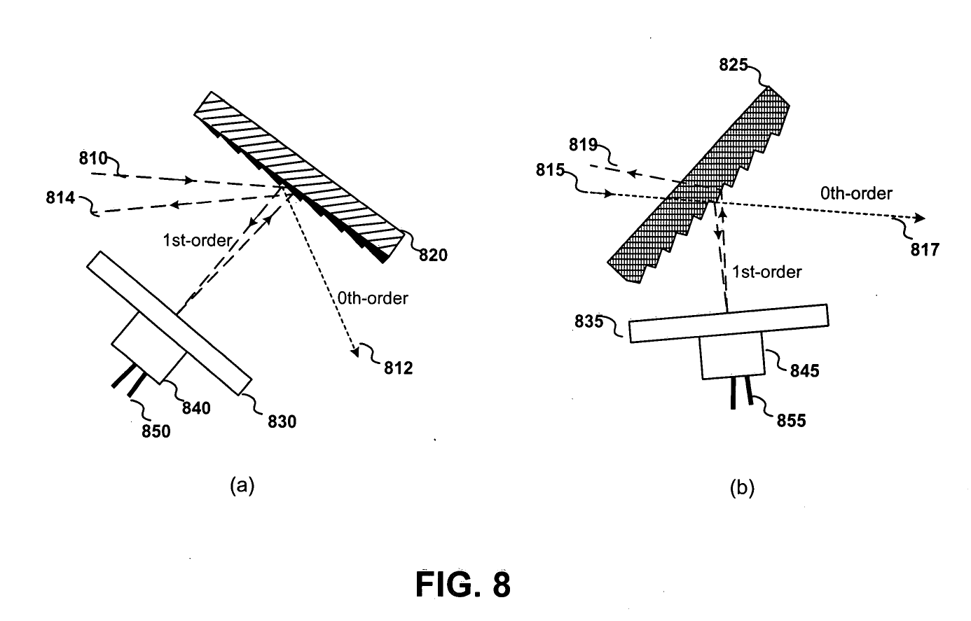

With reference to FIG. 8, there is shown illustrative alternative arrangements for grating/mirrors as may be used with my invention. In FIG. 8(a), the input signal 810 is diffracted from stationary reflective diffraction grating 820 and illuminates mirror 830 that is positioned on tip/tilt stage 840 such that it is controllably tiltable by applying appropriate control signals through contacts 850. Mirror 830, is oriented such that a reflected signal is incident on reflective diffraction grating 820 where it is diffracted a second time. As can be appreciated, this configuration provides approximately twice the change in output angle as a function of input wavelength (spectral dispersion) as compared with configurations not exhibiting this “double diffraction”.

Additionally, with reference to FIG. 8(a), shown therein are both zeroth-order 812 and non-zeroth-order 814 signals (in this example they are labeled as “1^{st} order”) reflected from the surface of the grating 820. As noted prior, the zeroth-order signal 812 is used to determine/measure positional information about the movable element (in this instance, the mirror 830). The non-zeroth-order signal 814, is directed to an output which may be an optically useful aperture or other output such as a slit, whether uniform, tapered, stepped or varying, depending upon the particular nomenclature used.

FIG. 8(b) is an additional variation in which input signal 815 is diffracted in passing through transmissive diffraction grating 825 then is incident upon first surface mirror 835 also mounted on tip/tilt stage 845. The reflected signal is diffracted again by a second pass through the transmissive grating 825 thereby producing output, first-order signal 819. Similar to that shown for the discussion of FIG. 8(a), in this FIG. 8(b) both zeroth-order 817 and non-zeroth-order 819 signals are shown. As before, the zeroth-order 817 signals are used to determine positional information about the movable element (in this example, the mirror 835) and the non-zeroth-order 819 signals are directed to a suitable optical output. Lastly, while the non-zeroth-order 819 signals are shown labeled as “1^{st} order”, our invention is not so limited and other order signals may be directed to output(s) as well.

Of course, it will be understood by those skilled in the art that the foregoing is merely illustrative of the principles of this invention, and that various modifications can be made by those skilled in the art without departing from the scope and spirit of the invention. Accordingly, my invention is to be limited only by the scope of the claims attached hereto.

1. In an optical device having at least one movable element, a method of operating the optical device comprising the steps of:
receiving an optical signal from an optical input aperture;
diffracting the optical signal into one or more chromatically dispersed non-zeroth-order components and a non-chromatically dispersed zeroth-order component; and
directing one of the non-zeroth-order components to an optical output;
CHARACTERIZED IN THAT:
positional feedback information about the movable element is determined. from the zeroth-order optical signal.

2. The method according to claim 1 further comprising the step of:
directing the zeroth-order component to a position detector.

3. The method according to claim 2 further comprising the step of:
directing the optical signal to the movable element.

4. The method according to claim 3 wherein the optical-signal directing, the zeroth-order-component directing, and the non-zeroth-order-component directing is performed by a common optical element.

5. The method according to claim 4 wherein the common optical element is a lens.

6. The method according to claim 1 wherein the diffracting step is performed by the action of the movable element and that movable element is a diffraction grating.

7. The method according to claim 1 further comprising the step of:
positioning the movable element based upon the positional feedback information.

8. The method according to claim 1 wherein the movable element is a mirror.

9. The method according to claim 1 wherein the optical input aperture comprises a plurality of input apertures.

10. The method according to claim 1 wherein the optical output comprises a tapered slit.

11. The method according to claim 1 further comprising the step of:
chopping the non-zeroth order components such that desirable signal/noise characteristics are realized.

12. An optical device comprising:
an input for receiving an optical signal;
a diffractor, for diffracting the optical signal into a one or more chromatically dispersed non-zeroth-order components and a non-chromatically-dispersed zeroth-order component;
a movable reflector, for selectively directing one of the non-zeroth order components to an output; and
a position detector; responsive to the zeroth-order component; for providing positional feedback information about the movable reflector.

13. The optical device according to claim 7 wherein the movable reflector is responsive to control signals determined from the positional feedback information.

14. The optical device according to claim 7 wherein the diffractor is a diffraction grating.

15. The optical device according to claim 7 wherein the diffractor and the movable reflector are the same optical element and that same optical element comprises a grating.

16. The optical device according to claim 8 further comprising an optical element for directing the input optical signal to the diffractor.

17. The optical device according to claim 8 further comprising an optical element for directing the input optical signal to the diffractor and a non-zeroth-order component to the output.

18. The optical device according to claim 12 further comprising an optical element for directing the zeroth-order component to the position detector.

19. The optical device according to claim 13 wherein the input optical signal director element, the non-zeroth-order directing element and the zeroth-order directing element are a common optical element.

20. The optical device according to claim 14 wherein the common optical element comprises a lens.

21. The optical device according to claim 12 wherein the input comprises one or more apertures.

22. The optical device according to claim 12 wherein the output comprises a tapered slit.

23. An optical device comprising:
means for inputting an optical signal;
means for diffracting the optical signal into one or more chromatically dispersed non-zeroth-order components and a non-chromatically dispersed zeroth-order component;
means for directing, one of the non-zeroth components to an output; and
means for determining, a position of the directing means from information derived from the zeroth-order component.

24. The optical device according to claim 16 further comprising a means for directing the zeroth-order component to the position determining means.

25. The optical device according to claim 17 wherein the zeroth-order component directing means and the non-zeroth order directing means are lenses.

26. The optical device according to claim 17 wherein the zeroth-order component directing means and the non-zeroth order directing means comprise a common lens.

27. The optical device according to claim 23 further comprising:
means for chopping the output directed components.
